(19) United States
(12) Patent Application Publication
(10) Pub. No.: US 2015/0326602 A1
(43) Pub. Date: Nov. 12, 2015

(54) CLEAN-UP OF UN-REASSEMBLED DATA FRAGMENTS

(71) Applicants: Mark V. Deisinger, ROSEVILLE, MN (US); ALLYN D. SMITH, ROSEVILLE, MN (US)

(72) Inventors: Mark V. Deisinger, ROSEVILLE, MN (US); ALLYN D. SMITH, ROSEVILLE, MN (US)

(73) Assignee: UNISYS CORPORATION, BLUE BELL, PA (US)

(21) Appl. No.: 14/273,624

(22) Filed: May 9, 2014

(51) Int. Cl. H04L 29/06

(52) U.S. Cl. CPC H04L 63/1441; H04L 63/1458

(57) ABSTRACT

A receiving device storing fragments may detect a total usage of storage space, such as a number of used queue banks (QBs), by un-reassembled fragments and take action when the total usage of storage space reaches a threshold level. For example, additional fragments may be rejected for a period of time after the threshold level is reached. In another example, the un-reassembled fragments may be cleaned up after the threshold level is reached. In yet another example, the reaching of the threshold level may be logged.

### FIELD OF THE DISCLOSURE

The instant disclosure relates to computer networks. More specifically, this disclosure relates to transferring data over computer networks,

### BACKGROUND

Data transfer between devices on a network involves fragmenting the data into individual chunks of data and formatting those individual chunks of data into data packets with certain header information to assist the chunk of data in reaching a desired final destination. When data is fragmented into individual chunks of data, the formatted data packets for the chunks of data include identifier information to allow a receiving device to match up the chunks of data and recreate the original complete data.

Because fragments of data may arrive in any order at the receiving device, the receiving device stores the fragments until it determines that all fragments have been received and that the data may be reassembled from the fragments. However, storing fragments of data for an unlimited period, or even a large period of time, when the data that the fragments belong to is not complete, creates vulnerabilities for the receiving device.

One vulnerability is that a malicious network presence could take advantage of vulnerabilities in the fragment reassembly algorithms of Internet Protocol (IP) to engender a Denial of Service (DoS) attack. The fragment reassembly DoS attack is an attempt by the malicious entity to flood the receiving device IP protocol machine with a stream of datagram fragments that will never resolve into complete datagrams, thus sapping resources in the receiving device's IP handler. This puts the IP handler in a bind, as it attempts to balance throughput with resource limitations in the face of a malicious attack.

In one conventional system, a periodic timer invokes an algorithm to check each chain of fragments to ensure that incomplete datagrams that have had no activity recently are removed from the active list and their resources returned for use. However, although such a periodic cheek can reduce backlog of fragments for reassembly by removing stale fragments, a periodic check is insufficient to prevent a denial of service (DoS) attack.

### SUMMARY

A receiving device storing fragments may detect a total usage of storage space, such as a number of used queue banks (QBs), by un-reassembled fragments and take action when the total usage of storage space reaches a threshold level. For example, additional fragments may be rejected for a period of time after the threshold level is reached. In another example, the un-reassembled fragments may be cleaned up after the threshold level is reached. In yet another example, the reaching of the threshold level may be logged.

Checks on the un-reassembled fragments may be performed after receiving the fragments and, if any fragment is invalid, then the fragment may be discarded.

According to one embodiment, a method may include receiving data at a network interface; inserting the data into one or more queue banks; linking the one or more queue banks to a reassembly chain for the network interface; determining a number of queue banks linked to the reassembly chain; and when the number of queue banks exceeds a predetermined threshold, discarding additional data received at the network interface.

According to another embodiment, a computer program product may include a non-transitory computer readable medium having code to perform the steps of receiving data at a network interface; inserting the data into one or more queue banks; linking the one or more queue banks to a reassembly chain for the network interface; determining a number of queue banks linked to the reassembly chain; and when the number of queue banks exceeds a predetermined threshold, discarding additional data received at the network interface.

According to yet another embodiment, an apparatus may include a memory and a processor coupled to the memory, wherein the processor is configured to perform the steps of receiving data at a network interface; inserting the data into one or more queue banks; linking the one or more queue banks to a reassembly chain for the network interface; determining a number of queue banks linked to the reassembly chain; and when the number of queue banks exceeds a predetermined threshold, discarding additional data received at the network interface.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating receipt of fragments of data according to one embodiment of the disclosure.

FIG. 2 is a flow chart illustrating a method of reassembling fragments of data according to one embodiment of the disclosure.

FIG. 3 is a flow chart illustrating a method of reassembling fragments of data according to another embodiment of the disclosure.

FIG. 4 is a block diagram illustrating a computer network according to one embodiment of the disclosure.

FIG. 5 is a block diagram illustrating a computer system according to one embodiment of the disclosure.

### DETAILED DESCRIPTION

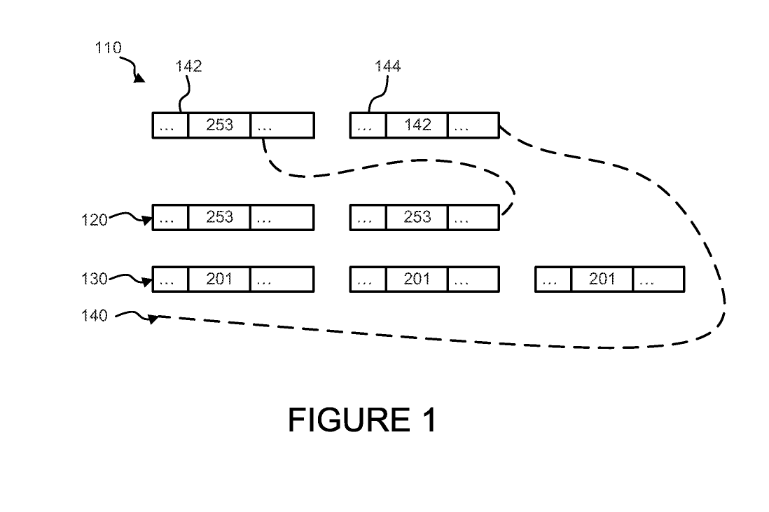

FIG. 1 is a block diagram illustrating receipt of fragments of data. according to one embodiment of the disclosure. A collection of fragments 110 may be associated through identifier values inserted in the fragments. Fragments with like identifier values are linked together into fragment chains, such as chains 120 and 130. When a new fragment 142 is received, the fragment 142 may be matched to the chain 120 by an identifier value and inserted into the chain 120. When a new fragment 144 is received not matching either the chain 120 or 130, the new fragment 144 may be inserted in a new chain 140.

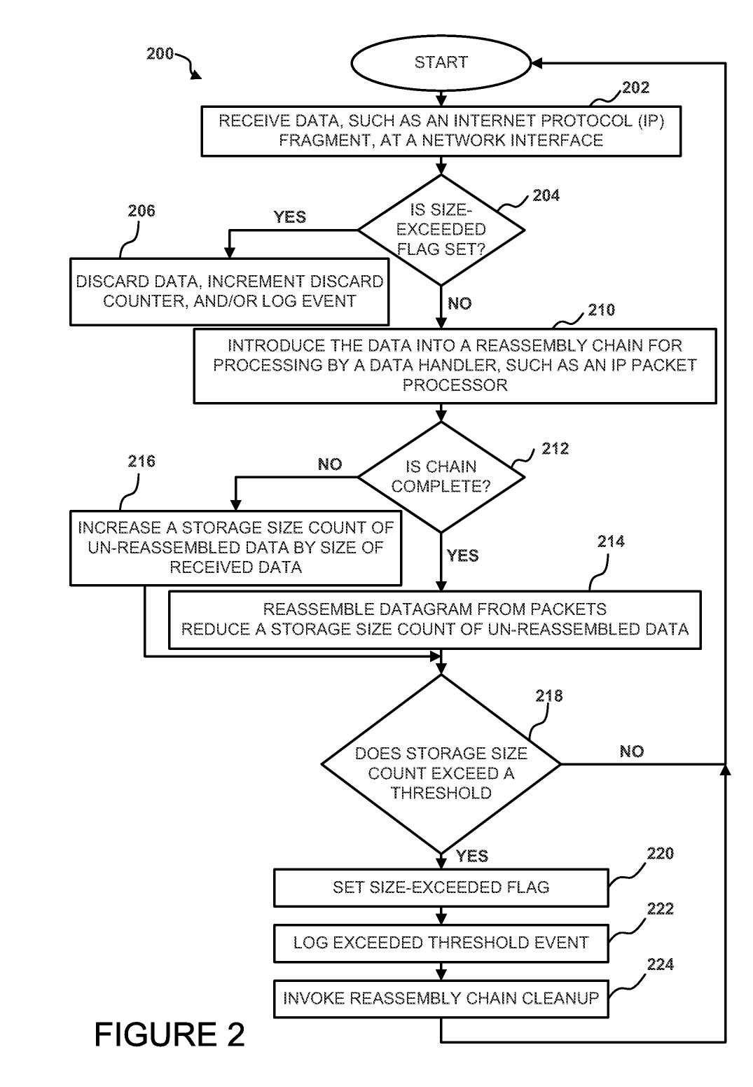

One method for processing received fragments is shown in FIG. 2. FIG. 2 is a flow chart illustrating a method of reassembling fragments of data according to one embodiment of the disclosure. A method 200 begins at block 202 with receiving data, such as an Internet Protocol (IP) fragment. At block 204, a flag is checked to determine if a threshold. level of un-reassembled fragments are stored. If the flag is set at block 204, then the received data at block 202 may be discarded and a count of discarded fragments may be incremented. At block 206, the event of block 204 may be logged. In one embodiment, the logging may occur at a maximum interval, such as creating one log event per two seconds. Reassembly chain cleanup may be invoked when logging is performed.

If the flag is not set at block 204, then the method 200 proceeds to block 210 to introduce the fragment into the reassembly chains. At block 212, it is determined whether the insertion of the fragment at block 210 results in a datagram being reassembled. If so, then a storage size of the un-reassembled fragments may be reduced by the number of fragments in the reassembled datagram at block 214. If no datagram is complete at block 212, then the method 200 proceeds to block 216 to increase the storage size of the un-reassembled fragments by an amount of storage consumed by the received fragment of block 202. At block 218, it is determined whether the updated storage count of un-reassembled fragments exceeds a threshold level. In one embodiment, the un-reassembled fragments may be stored in queue banks (QBs), and the threshold level may be set at approximately 3000 queue banks (QBs).

When the threshold level is exceeded at block 218, the method 200 may proceed to block 220 to set the flag as true, to block 222 to log exceeding the threshold level, and to block 224 to invoke reassembly chain cleanup. Cleanup of block 224 may include setting a timeout value for determining whether storage has been reduced. When storage is reduced, such as when queue banks (QBs) are released and incomplete datagrams are discarded, the storage count may be reduced. When the storage count is reduced below a second threshold level, such as approximately half of the first threshold level, the flag may be cleared.

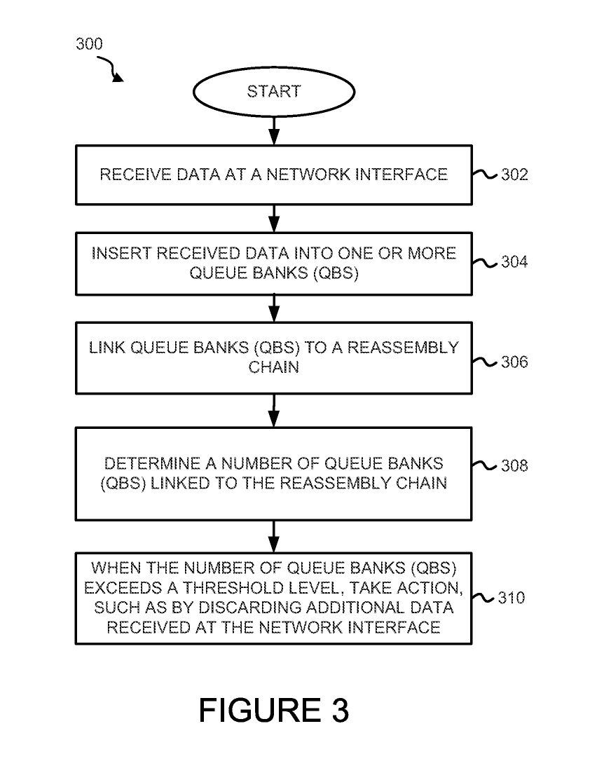

FIG. 3 is a flow chart illustrating a method of reassembling fragments of data according to another embodiment of the disclosure. A method 300 begins at block 302 with receiving data at a network interface. At block 304, the data may be inserted into one or more queue banks. At block 306, the one or more queue banks may be linked to a reassembly chain for the network interface. At block 308, a number of queue banks linked to the reassembly chain may be determined. At block 310, when the number of queue banks exceeds a predetermined threshold, additional data received at the network interface may be discarded.

After data is received at the network interface, the data may be checked and discarded if determined to be invalid. In one embodiment, the checks may be performed before further processing on the received data by an IP header. The checks may be performed before inserting the data into a queue bank.

In one embodiment, incoming data fragments may be processed by an ip_input( ) function called by an input activity to handle incoming IP packets. This routine may perform some checks and determine that the packet is a fragment, after which the fragment is queued for processing. Processing of the fragment may be performed by an ip_fragment input( ) function that performs additional checks and may be performed by a reassemble_datagram( ) function that performs additional checks on the received data fragment. In one embodiment, the checks for validity described above may be performed in the ip_input( ) function.

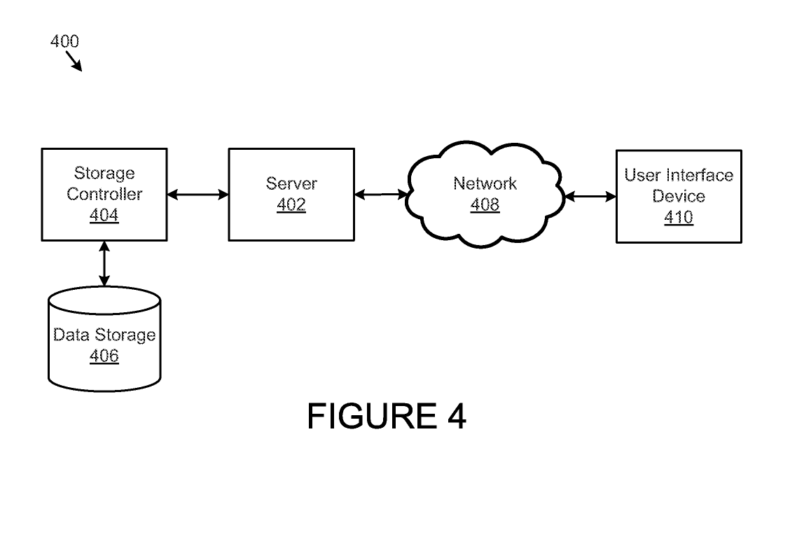

FIG. 4 illustrates one embodiment of a system 400 for an information system. The system 400 may include a server 402, a data storage device 406, a network 408, and a user interface device 410. In a further embodiment, the system 400 may include a storage controller 404, or storage server configured to manage data communications between the data storage device 406 and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone, or other mobile communication device having access to the network 408. In a further embodiment, the user interface device 410 may access the Internet or other wide area or local area network to access a web application or web service hosted by the server 402 and may provide a user interface, such as to adjust settings or view the logs generated when data fragments are received.

The network 408 may facilitate communications of data between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

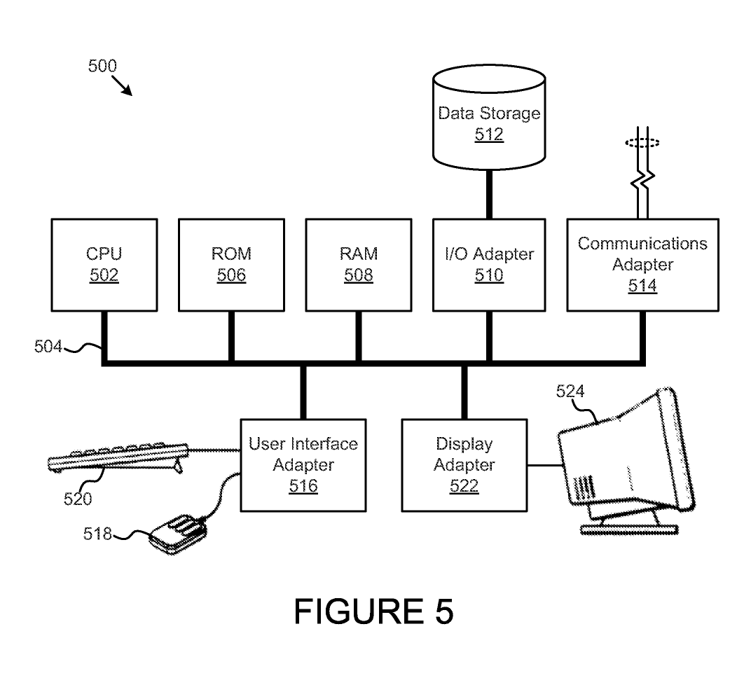

FIG. 5 illustrates a computer system 500 adapted according to certain embodiments of the server 402 and/or the user interface device 410. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 may also include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data, and both the RAM 508 and the ROM 506 may be randomly accessed.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 408, which may be one or more of a LAN, WAN, and/or the Internet. The user interface adapter 516 couples user input devices, such as a keyboard 520, a pointing device 518, and/or a touch screen (not shown) to the computer system 500. The keyboard 520 may be an on-screen keyboard displayed on a touch panel. The display adapter 522 may be driven by the CPU 502 to control the display on the display device 524. Any of the devices 502-522 may be physical and/or logical.

The applications of the present disclosure are not limited to the architecture of computer system 500. Rather the computer system 500 is provided as an example of one type of computing device that may be adapted to perform the functions of the server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 500 may be virtualized for access by multiple users and/or applications.

If implemented in firmware and/or software, the functions described above, such as described with reference to FIG. 2 and FIG. 3, may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. Additionally, the firmware and/or software may be executed by processors integrated with components described above.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving data at a network interface;
inserting the data into storage for un-reassembled data fragments;
determining a size of the un-reassembled data fragments; and
when the size exceeds a predetermined threshold, discarding additional data received at the network interface.

2. The method of claim 1, wherein inserting the data into storage comprises:
inserting the data into one or more queue banks; and
linking the one or more queue banks to a reassembly chain for the network interface,
wherein determining the size comprises determining a number of queue banks linked to the reassembly chain.

3. The method of claim 2, further comprising, after linking the one or more queue banks to the reassembly chain, assembling a datagram from data stored in queue banks and linked in the reassembly chain, wherein the step of assembling is performed before the step of determining the number of queue banks.

4. The method of claim 1, further comprising, when the size exceeds the predetermined threshold, logging a threshold-exceeded event.

5. The method of claim 1, further comprising, when the size exceeds the predetermined threshold, invoking a cleanup process for the storage of un-reassembled data fragments.

6. The method of claim 5, further comprising, when the size is reduced by the cleanup process to below a second predetermined threshold, accepting additional data received at the network interface.

7. The method of claim 1, further comprising, after receiving the data at the network interface:
checking the validity of the received data and discarding the received data if the received data is determined to be invalid.

8. A computer program product, comprising:
a non-transitory computer readable medium comprising code to perform the steps comprising:
receiving data at a network interface;
inserting the data into storage for un-reassembled data fragments;
determining a size of the un-reassembled data fragments; and
when the size exceeds a predetermined threshold, discarding additional data received at the network interface.

9. The computer program product of claim 8, wherein inserting the data into storage comprises:
inserting the data into one or more queue banks; and
linking the one or more queue banks to a reassembly chain for the network interface, and
wherein determining the size comprises determining a number of queue banks linked to the reassembly chain.

10. The computer program product of claim 9, wherein the medium further comprises code to, after linking the one or more queue banks to the reassembly chain, assemble a datagram from data stored in queue banks and linked in the reassembly chain, wherein the step of assembling is performed before the step of determining the number of queue banks.

11. The computer program product of claim 8, wherein the medium further comprises code to, when the size exceeds the predetermined threshold, log a threshold-exceeded event.

12. The computer program product of claim 8, wherein the medium further comprises code to invoke, when the size exceeds the predetermined threshold, a cleanup process for the storage of tin-reassembled data fragments.

13. The computer program product of claim 12, wherein the medium further comprises code to accept, when the size is reduced by the cleanup process to below a second predetermined threshold, additional data received at the network interface.

14. The computer program product of claim 8, wherein the medium further comprises code to check, after receiving the data at the network interface, the validity of the received data and code to discard the received data if the received data is determined to be invalid.

15. An apparatus, comprising:
a memory; and
a processor coupled to the memory, wherein the processor is configured to perform the steps comprising:
receiving data at a network interface;
inserting the data into storage for un-reassembled data fragments;
determining a size of the un-reassembled data fragments; and
when the size exceeds a predetermined threshold, discarding additional data received at the network interface.

16. The apparatus of claim 15, wherein the processor is further configured to log, when the size exceeds the predetermined threshold, a threshold-exceeded event.

17. The apparatus of claim 15, wherein the processor is further configured to invoke, when the size exceeds the predetermined threshold, a cleanup process for the storage of un-reassembled data fragments.

18. The apparatus of claim 17, wherein the processor is further configured to accept, when the size is reduced by the cleanup process to below a second predetermined threshold, additional data received at the network interface.

19. The apparatus of claim 15, wherein the processor is further configured to:
check the validity of the received data alter receiving the data at the network interface and discard the received data if the received data is determined to be invalid.
